(19) United States
(12) Patent Application Publication
(10) Pub. No.: US 2016/0283666 A1
(43) Pub. Date: Sep. 29, 2016

(54) COORDINATING RECORD SHARING

(71) Applicant: CareDox Inc., New York, NY (US)

(72) Inventors: Yechezkel Kutscher, New York, NY (US); Benjamin John Maisano, Mendham, NJ (US)

(21) Appl. No.: 15/079,906

(22) Filed: Mar. 24, 2016

Related U.S. Application Data
(60) Provisional application No. 62/137,733, filed on Mar. 24, 2015.

(51) Int. Cl. G06F 19/00

(52) U.S. Cl. CPC G06F 19/322

(57) ABSTRACT

An immunization registry server is configured to generate one or more integrated immunization records using healthcare information obtained from different healthcare information sources. These healthcare information sources include the parents or guardians associated with a student/patient, a student information system, a state immunization registry, and a healthcare provider for the student/patient. In obtaining the healthcare information from these sources, the immunization registry server is configured to determine whether there are any discrepancies in the obtained healthcare information and identify them accordingly. In addition, the immunization registry server is configured with a variety of state-specific adapters that are invoked to obtain the healthcare information from the various state immunization registries. The immunization registry server also implements a data model that facilitates granting access to portions of an integrated immunization record depending on the permissions associated with shared portions of the integrated immunization record.

### CROSS-REFERENCE TO RELATED APPLICATIONS

This application claims the benefit of priority to U.S. Pat. App. No. 62/137,733, filed Mar. 24, 2015 and titled “COORDINATING RECORD SHARING.” the disclosure of which is hereby incorporated by reference in its entirety.

### TECHNICAL FIELD

The subject matter disclosed herein generally relates to integrating healthcare records, stored across various domains and according to various standards and/or formats, into a universal healthcare record, which can be accessed by one or more authorized users or medical professionals.

### BACKGROUND

Parents often take their children to the physician to have vaccinations administered at various stages/ages. For a community to achieve immunization. studies estimate that 85+% of the population should be vaccinated. States, school districts, and individual schools often have specific requirements for students to have vaccinations, largely guided by the Advisory Committee on Immunization Practices (ACIP), Center for Disease Control (CDC), and other government health agencies.

Traditionally, a health care provider (e.g., doctor's office, hospital, clinic. etc.) administering a vaccination registers the administration of the vaccine with a state run Immunization Information Registry System (IIS). The registered administration may include such information as the date of the vaccination and the dose and/or sequence provided to the patient. At this time, many states require registering the vaccination while others encourage it. Furthermore, the laws between states may vary on the type of information that it is to be registered. This registered immunization administration information can then be further analyzed and/or utilized by other healthcare providers, insurance companies, and government agencies for research purposes, as well as to determine the vulnerability of a community in the event of an outbreak.

In some circumstances, a school may require that students provide documentation to demonstrate that they have received certain vaccinations prior to being enrolled. Should a student be unable to provide the requisite documentation. he or she may be denied enrollment. This requirement can be challenging for parents or students to overcome, such as where a student may move school districts or where the parent and/or student has been unable to maintain records of the student's vaccinations. This also suggests a broader problem, namely, that patients do not have ongoing access to their medical records.

To obtain the requisite vaccination information, a school may provide a vaccination form that is to be completed by a student's physician. However, in some circumstances, the physician completing the vaccination form is not the physician that administered the student's vaccinations. Furthermore, and to add additional complications, a physician may receive the form through one or more non-electronic communication channels (e.g., mail or walk-in), the physician may charge a fee to complete the form, and, when the vaccination form is ready to be returned, the vaccination form may be lost by a third party.

In this ongoing chain of paper communication, the parents must then pass the vaccination form to the school. The school then has a nurse or staff member review the form, re-enter it into their electronic records system and/or file the paper version. Being that current processes require parents to coordinate the information exchange between the healthcare provider and the school, significant inefficiencies result, on the part of the parent, the healthcare provider, and the school. Additionally, as families move from school to school, district to district, or state to state, the referenced records may become incomplete and even more difficult to obtain.

### BRIEF DESCRIPTION OF THE DRAWINGS

Some embodiments are illustrated by way of example and not limitation in the figures of the accompanying drawings.

FIG. 1 is a block diagram illustrating a networked architecture for integrating healthcare records into a universal healthcare record, according to an example embodiment.

FIG. 2 illustrates an immunization registry server for integrating the healthcare records obtained from the systems illustrated in FIG. 1, according to an example embodiment.

FIG. 3 illustrates obtaining and integrating healthcare records using one or more state immunization registry adapters, according to an example embodiment.

FIG. 4 illustrates identifying different healthcare records across different domains corresponding to an identified patient, according to an example embodiment.

FIG. 5 illustrates a data model for an integrated immunization record, according to an example embodiment.

FIG. 6 illustrates one implementation of the data model illustrated in FIG. 5, according to an example embodiment.

FIGS. 7A-7B illustrate a method, in accordance with an example embodiment, for integrating healthcare records obtained from various sources into an integrated immunization record.

FIG. 8 is a block diagram illustrating components of a machine. according to some example embodiments, able to read instructions from a machine-readable medium (e.g., a machine-readable storage medium) and perform any one or more of the methodologies discussed herein.

### DETAILED DESCRIPTION

This disclosure provides an immunization registry server that includes. in one embodiment, a machine-readable medium storing computer-executable instructions and at least one hardware processor communicatively coupled to the machine-readable medium that, when the computer-executable instructions are executed, configures the system to receive a request to create an integrated immunization record, the request including initial demographic information for a patient to be associated with the integrated immunization record and obtain student roster data associated with the patient from a student information system associated with an educational institution, the student roster data including healthcare information maintained by the student information system. The system is also configured to determine a state-specific adapter based on the initial demographic information, the state-specific adapter configured to obtain state immunization data from a state immunization system associated with a corresponding state identified in the initial demographic information and obtain the state immunization data corresponding to the patient using the determined state-specific adapter. Further still, the system is configured to integrate the obtained state immunization data and the obtained student roster data into an integrated immunization record, the integrated immunization record comprising at least a portion of the obtained student roster data and a portion of the state immunization data, and generate the integrated immunization record corresponding to the patient.

In another embodiment, the system is further configured to determine whether a discrepancy exists in the state immunization data according to one or more integration integrity rules, at least one integration integrity rule specifying an immunization schedule for an immunization associated with the patient.

In a further embodiment, the system determines that a discrepancy exists in the state immunization data in response to a determination that an immunization schedule associated with the patient differs from the specified immunization schedule.

In yet another embodiment, the state-specific adapter includes one or more student roster data matching rules specifying how the obtained student roster data is to be matched with the state immunization data to be obtained from the state immunization system.

In yet a further embodiment, the system is further configured to select at least one healthcare transaction standard to obtain the state immunization data, the at least one healthcare transaction standard being selected from a plurality of healthcare transaction standards.

In another embodiment, the integrated immunization record is generated to conform with a predefined data model, the predefined data model identifying a portion of the integrated immunization record as a shared portion that is accessible by a plurality of users.

In a further embodiment, the system is further configured to provide the shared portion of the integrated immunization record in response to a request by a user selected from the plurality of users, the user being other than the patient associated with the integrated immunization record.

Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

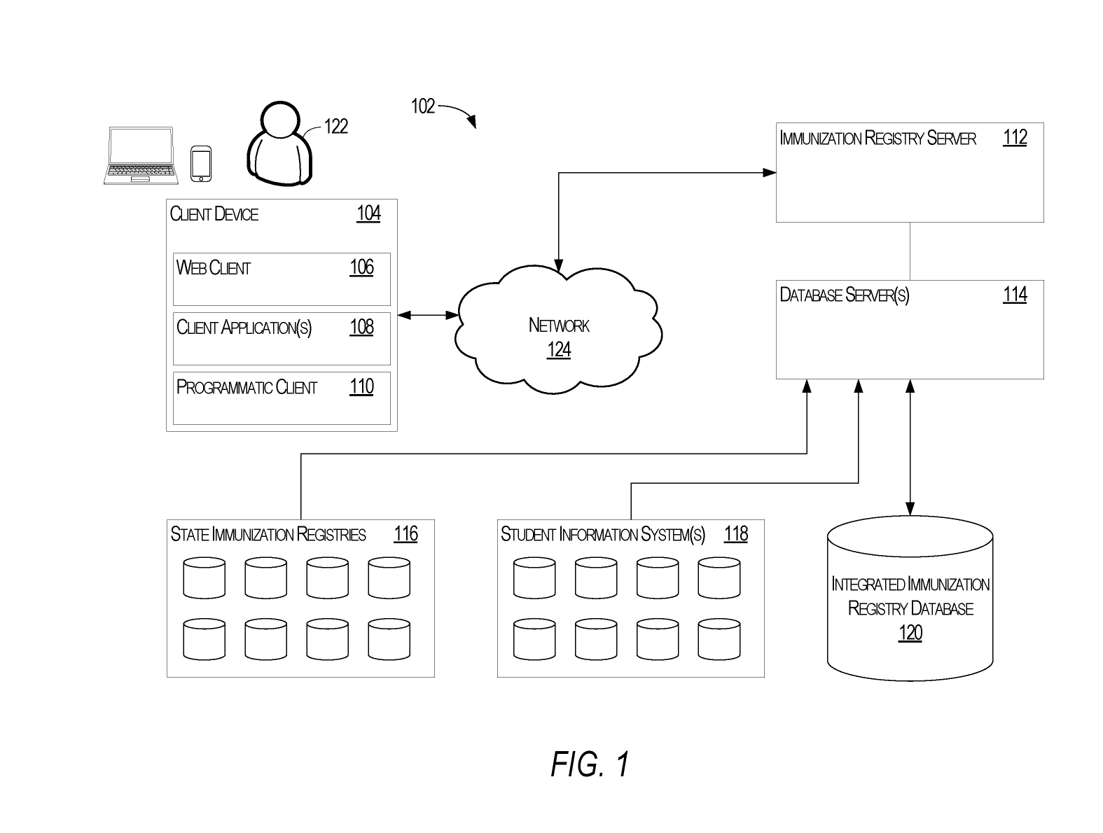

FIG. 1 is a block diagram illustrating a networked architecture 102 for integrating healthcare records into a universal healthcare record, according to an example embodiment. In one embodiment, an immunization registry server 112 provides server-side functionality via a network 124 (e.g., the Internet or wide area network (WAN)) to one or more client devices 104. FIG. 1 illustrates, for example a web client 106 (e.g., a browser, such as the Internet Explorer® browser developed by Microsoft® Corporation of Redmond. Washington State), client application(s) 108, and a programmatic client 110 executing on client device 104. The immunization registry server 112 is further communicatively coupled with one or more database servers 114 that provide access to one or more systems or databases 116-120.

The client device 104 may comprise, but is not limited to, a mobile phone, desktop computer, laptop, portable digital assistants (PDAs), smart phone. tablet, ultra book, netbook, laptop, multi-processor system. microprocessor-based or programmable consumer electronic, or any other communication device that a user 122 may utilize to access the immunization registry server 112. In some embodiments, the client device 104 may comprise a display module (not shown) to display information (e.g., in the form of user interfaces). In further embodiments, the client device 104 may comprise one or more of touch screens, accelerometers, gyroscopes, cameras, microphones. global positioning system (GPS) devices, and so forth. The client device 104 may be a device of a user 122 that is used to access, view, edit, or create one or more universal healthcare records maintained by the immunization registry server 112.

In one embodiment, the immunization registry server 112 is a network-based appliance that responds to initialization requests or requests for one or more universal healthcare records from the client device 104. One or more users 122 may be a person, a machine, or other means of interacting with the client device 104. In various embodiments, the user 122 is not part of the networked architecture 102. but may interact with the networked architecture 102 via the client device 104 or another means. For example, one or more portions of the network 124 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet. a portion of the Public Switched Telephone Network (PSTN). a cellular telephone network, a wireless network, a WiFi network, a WiMax network, another type of network, or a combination of two or more such networks.

The client device 104 may include one or more applications (also referred to as “apps”) such as, but not limited to, a web browser, messaging application, electronic mail (email) application, a healthcare record or healthcare provider access client, and the like. In some embodiments. if a healthcare record access client is included in the client device 104, then this application is configured to locally provide the user interface and at least some of the functionalities with the application configured to communicate with the immunization registry server 112, on an as-needed basis, for data and/or processing capabilities not locally available (e.g., for access to a patient profile, to authenticate a user 122, to identify one or more accessible healthcare records, etc.). Conversely, if the healthcare record access client is not included in the client device 104, the client device 104 may use its web browser to access the initialization and/or healthcare record functionalities of the immunization registry server 112.

One or more users 122 may be a person, a machine, or other means of interacting with the client device 104. In example embodiments, the user 122 is not part of the networked architecture 102, but may interact with the networked architecture 102 via the client device 104 or other means. For instance, the user 122 provides input (e.g., touch screen input or alphanumeric input) to the client device 104 and the input is communicated to the networked architecture 102 via the network 124. In this instance, the immunization registry server 112. in response to receiving the input from the user 122, communicates information to the client device 104 via the network 124 to be presented to the user 122. In this way, the user 122 can interact with the immunization registry server 112 using the client device 104.

Further, while the client-server-based networked architecture 102 shown in FIG. 1 employs a client-server architecture, the present subject matter is of course not limited to such an architecture. and could equally well find application in a distributed, or peer-to-peer, architecture system, for example.

In addition to the client device 104, the immunization registry server 112 communicates with other one or more database server(s) 114 and/or database(s) 116-120. In one embodiment, the immunization registry server 112 is communicatively coupled to various state immunization registries 116. one or more student information system(s) 118, and an integrated immunization registry database 120. The various systems and/or databases 116-120 may be implemented as one or more types of databases including, but not limited to, hierarchical databases, relational databases, object-oriented databases, one or more flat files, or combinations thereof.

The state immunization registries 116 include one or more electronic databases that store immunization records for patients of the corresponding state. The immunization records may record and track immunization dates of children and adults, and may further include one or more schedules for identifying when a given immunization should occur. In one embodiment, one or more of the state immunization registries 116 provide an Application Programming Interface (API) or other communication interface for electronically communicating with the respective registry. Examples of state registries 116 include the Wisconsin Immunization Registry (WIR), the Vermont Immunization Registry (VIR). the New York State Immunization Information System (NYSIIS). and other such immunization registries. Additionally or alternatively, the state immunization registries 116 include those registries maintained at other levels of government, such as city registries, county registries, township registries, and other such registries.

As discussed below, the disclosed immunization registry server 112 is configured to access a state immunization registry 116 for an identified patient and obtain immunization information for the identified patient. In particular, and in one embodiment, the immunization registry server 112 is configured with state-specific adapters for obtaining the immunization records for corresponding states and/or government entities. However, there may be instances where the immunization information is incomplete or has errors (e.g., through human error), and the immunization registry server 112 is configured to reconcile these discrepancies in the retrieved immunization information. After the discrepancies are resolved (or have been flagged or identified for further review), the immunization information retrieved in this manner is then incorporated into a universal healthcare record.

To complete a patient's healthcare history, the universal healthcare record also incorporates information obtained from one or more schools that a patient is attending or has attended. Accordingly, the immunization registry server 112 is also communicatively coupled to one or more student information system(s) 118 (e.g., either directly or via one or more database server(s) 114). As known to one of ordinary skill in the art, a student information system, such as the one identified by reference number 118, provides such functions as registering students for one or more school courses, documenting grading transcripts, recording results of student test and other assessment scores, building student schedules, tracking student attendance, and managing many other student-related data needs in a school. In addition, a student information system can be configured to maintain health records for identified students that are attending, or have attended, the school. In some implementations, a student information system provides an API or other electronic communication interface for obtaining records from, and interacting with, the student information system.

However, there are technical challenges in incorporating student information into the disclosed universal healthcare record. In particular, schools can have discretion in deciding how to implement their specific student information system; accordingly, the specific implementation of the student information system(s) 118 may vary from school to school (e.g., a first school may use a first student information system that has an API different from a second student information system used by a second school). Thus, and as briefly mentioned above, the immunization registry server 112 is configured, in one embodiment, with adapters specific to the particular student information system 118 so that it may obtain health records for an identified student. In this manner, the disclosed adapters provide a technical solution to the challenge of inter-system communications, which is a technical challenge that arises in the field of electronic information aggregation and consolidation.

The immunization registry server 112 is also communicatively coupled to an integrated immunization registry database 120. In one embodiment, the integrated immunization registry database 120 stores one or more universal health care records corresponding to individual patients. Moreover, a universal health record incorporates healthcare information obtained from the one or more of the state immunization registries 116, one or more student information system(s) 118, and any information provided by the patient or the patient's guardian. In this manner, the integrated immunization registry database 120 is a centralized repository for healthcare information for a given patient that provides state-level and school-level information.

Consistent with some embodiments, when a person, such as the patient or the patient's guardian, initially registers to join the immunization registry server 112. the person may be prompted to provide some personal information that assists the immunization registry server 112 in identifying this person and in retrieving his or her information from the one or more state immunization registries 116 or the one or more student information system(s) 118. This personal information may include his or her full legal name, age (e.g., birthdate), gender, contact information, any former legal names or surnames, a current address, any former addresses, the legal names of the person's siblings (for identification purposes), the birth order of the patient (e.g., where the person is from a multiple birth), and/or the names of any parents and/or guardians. The immunization registry server 112 may also request that the person complete an electronic consent form that authorizes the immunization registry server 112 to communicate with the student information systems 118 and/or the state immunization registries 116. In completing the electronic consent form, the immunization registry server 112 may further request that the person provide login and/or access information for accessing his or her healthcare information maintained by the student information systems 118 and/or state immunization registries 116.

Recognizing that a person's healthcare information is personal and private, the immunization registry server 112 may employ one or more securitization technologies to maintain the privacy of the healthcare information stored by the integrated immunization registry database 120. Such technologies include, but are not limited, encrypting the stored healthcare information, using two-factor authorization to identify a person accessing the immunization registry server 112. using various forms of biometric information to authorize and/or register a person (e.g., one or more fingerprints, retina scans, etc.), mailing a person a Personal Identification Number (PIN) (e.g., via the United States Postal Service) to authorize the person's access to the immunization registry server 112, and other such securitization technologies or combination of technologies.

In one embodiment, the immunization registry server 112 communicates with the various systems and/or databases 116-120 through one or more database server(s) 114. In this regard. the database server(s) 114 provide one or more interfaces and/or services for providing healthcare information to, modifying healthcare information in. removing healthcare information from, or otherwise interacting with, the systems and/or databases 116-120. For example, and without limitation, such interfaces and/or services may include one or more Application Programming Interfaces (APIs), one or more services provided via a Service-Oriented Architecture (“SOA”), one or more services provided via a REST-Oriented Architecture (“ROA”), or combinations thereof. In an alternative embodiment, the immunization registry server 112 communicates with the systems and/or databases 116-120 and includes a database client, engine. and/or module, for providing data to, modifying data stored within, and/or retrieving data from, the one or more systems and/or databases 116-120.

While the database server(s) 114 is illustrated as a single block, one of ordinary skill in the art will recognize that the database server(s) 114 may include one or more such servers. For example, the database server(s) 114 may include. but are not limited to, a Microsoft® Exchange Server, a Microsoft® Sharepoint® Server, a Lightweight Directory Access Protocol (“LDAP”) server, a MySQL database server, or any other server configured to provide access to one or more of the systems and/or databases 116-120. or combinations thereof. Accordingly, and in one embodiment, the database server(s) 114 are implemented by, and communicate with, the immunization registry server 112.

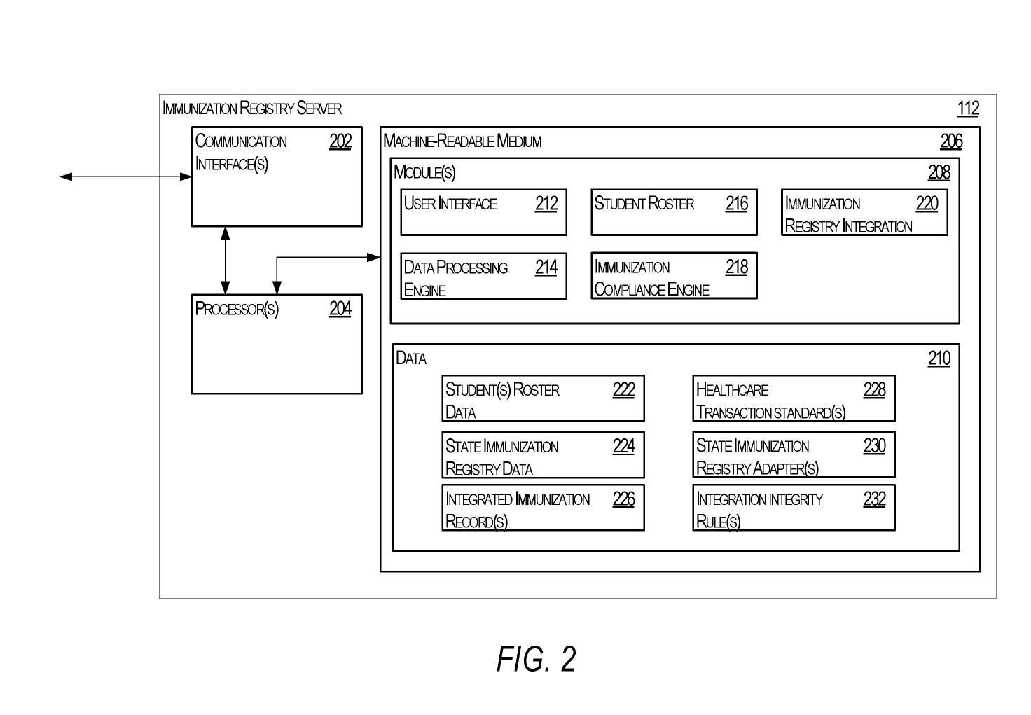

FIG. 2 further illustrates the immunization registry server 112 for integrating the healthcare records obtained from the systems and/or databases 116-120 illustrated in FIG. 1. according to an example embodiment. In one embodiment, the immunization registry server 112 includes one or more communication interface(s) 202, one or more processor(s) 204. and a machine-readable medium 206 that stores computer-executable instructions for one or more modules 208 and data 210 used to support one or more functionalities of the modules 208.

The various functional components of the immunization registry server 112 may reside on a single device or may be distributed across several computers in various arrangements. The various components of the immunization registry server 112 may furthermore, access one or more databases (e.g., systems and/or databases 116-120 or any of data 210). and each of the various components of the immunization registry server 112 may be in communication with one another. Further, while the components of FIG. 2 are discussed in the singular sense, it will be appreciated that in other embodiments multiple instances of the components may be employed.

The one or more communication interfaces 202 are configured to facilitate communications between the immunization registry server 112, the client device 104, and one or more of the database server(s) 114 and/or databases 116-120. The one or more communication interfaces 202 may include one or more wired interfaces (e.g., an Ethernet interface. Universal Serial Bus (“USB”) interface, a Thunderbolt® interface, etc.), one or more wireless interfaces (e.g., an IEEE 802.11b/g/n interface, a Bluetooth® interface, an IEEE 802.16 interface, etc.), or combinations of such wired and wireless interfaces.

The one or more processors 204 may be any type of commercially available processor, such as processors available from the Intel Corporation. Advanced Micro Devices, Texas Instruments, or other such processors. Further still. the one or more processors 204 may include one or more special-purpose processors, such as a Field-Programmable Gate Array (FPGA) or an Application Specific Integrated Circuit (ASIC). The one or more processors 204 may also include programmable logic or circuitry that is temporarily configured by software to perform certain operations. Thus, once configured by such software, the one or more processors 204 become specific machines (or specific components of a machine) uniquely tailored to perform the configured functions and are no longer general-purpose processors.

The machine-readable medium 206 includes various modules 208 and data 210 for implementing the immunization registry server 112. The machine-readable medium 206 includes one or more devices configured to store instructions and data temporarily or permanently and may include, but not be limited to, random-access memory (RAM). read-only memory (ROM), buffer memory. flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store the modules 208 and the data 210. Accordingly, the machine-readable medium 206 may be implemented as a single storage apparatus or device, or, alternatively and/or additionally, as “cloud-based” storage systems or storage networks that include multiple storage apparatus or devices. As shown in FIG. 2, the machine-readable medium 206 excludes signals per se.

In one embodiment, the modules 208 are written in a computer-programming and/or scripting language. Examples of such languages include, but are not limited to, C. C++, C#, Java, JavaScript, Perl, Python, Ruby, or any other computer programming and/or scripting language now known or later developed.

With reference to FIG. 2, the modules 208 of the immunization registry server 112 include, but are not limited to, a user interface module 212. a data processing engine 214, a student roster module 216, an immunization compliance engine 218, and an immunization registry integration module 220. The data 210 referenced and used by the modules 208 include student roster data 222 obtained by the student roster module 216, state immunization registry data 224 obtained by the immunization registry integration module 220, healthcare transaction standard(s) 228 and state immunization registry adapter(s) 230 for obtaining the state immunization registry data 224, and integration integrity rule(s) 232 for verifying the integrity of the obtained student(s) roster data 222 and/or state immunization registry data 224. The result from integrating the student(s) roster data 222 with the state immunization registry data 224 includes the integrated immunization record(s) 226. which are then stored in the integrated immunization registry database 120.

The user interface module 212 is configured to provide access to, and interactions with, the immunization registry server 112. In one embodiment, the user interface module 212 provides one or more graphical user interfaces, which may be provided using the Hypertext Transfer Protocol (HTTP). The graphical user interfaces are displayable by the client device 104 and accept input from the user 122 for interacting with the immunization registry server 112. Further still, the user interface module 212 may be configured to provide such interfaces to one or more clients displayable by the client device 104, such as the web client 106, one or more client applications 108, or the programmatic client 110. By interacting with the user interface module 212, the user 122 can request various webpages provided by the immunization registry server 112. Further still, the user interface module 212 is configured to communicate the healthcare information to the immunization registry server 112 and communicate data stored by one or more of the integrated immunization record(s) 226 for display by the client device 104.

The data processing engine 214 is configured to process information obtained from the client device 104 and to evaluate the student(s) roster data 222 and the state immunization registry data 224 obtained from the student information system(s) 118 and state immunization registries 116. respectively. In one embodiment. the data processing engine 214 performs several different operations in evaluating the obtained student(s) roster data 222 and the state immunization registry data 224. These operations include merging the student(s) roster data and the state immunization registry data into one or more integrated immunization record(s) 226, executing one or more integration integrity rule(s) 232 and evaluating the merged data of the integrated immunization record(s) 226 according to corresponding integration integrity rule(s) 232, identifying discrepancies in the merged data of the integrated immunization record(s) 226, maintaining a record of which rule(s) of the integration integrity rule(s) 232 were evaluated as being satisfied (or not satisfied), and other such operations or combination of operations. In one embodiment, the data processing engine 214 performs these evaluations and/or merges by instantiating the immunization registry integration module 220 and/or the immunization compliance engine 218.

The student roster module 216 is configured to obtain the student(s) roster data 222 from one or more of the student information system(s) 118. In one embodiment, the student roster module 216 is instantiated after an authorized user has authorized the student roster module 216 to communicate with the student information system(s) 118. In this context, an authorized user is a user who has been granted permission to authorize the student roster module 216 to obtain the student roster data 222. Such users may include, but are not limited to, the patient, the patient's parent or guardian, the patient's primary physician, a school administrator for a school being attended (or that has been attended) by the patient, or other such user or combination of users. Additionally or alternatively, the student(s) roster data 222 is provided to the immunization registry server 112, such as by the patient. the patient's guardian, or other authorized user, such that the immunization registry server 112 foregoes communications with the student information system(s) 118. In this additional or alternative embodiment, the student(s) roster data 222 is provided to the immunization registry server 112 for initialization purposes (e.g., via a machine-readable medium or the like). Afterwards, the immunization registry server 112 may be provided with updates to the student(s) roster data 222 or may communicate with the student information system(s) 118 for updates (to and/or from).

In one embodiment, the student(s) roster data 222 includes roster information about one or more students attending a given school. It should be understood that, in this context, the student(s) roster data 222 may include student roster information from one or more schools for one or more students. In one embodiment, the student(s) roster data 222 includes one or more student roster attributes that include, but are not limited, students' full legal name, students' date of birth, students' contact information (e.g., mailing address, phone numbers, e-mail addresses, etc.), students' current grade (or grades when he or she attended a specified school), the immunization requirements for the students and/or an immunization schedule for the students, student identifiers, and, where applicable, a state immunization registry identifier and/or credentials. As used in this context, a student roster attribute corresponds to an element of the student roster data (e.g., “Legal Name”) and the student roster attribute value corresponds to the value for the student roster attribute (e.g., “John Q. Smith”).

The immunization registry integration module 220 is configured to obtain the state immunization registry data 224. In one embodiment, the immunization registry integration module 220 is instantiated after an authorized user has authorized the immunization registry integration module 220 to communicate with one or more of the state immunization registries 116. In this context, an authorized user is a user who has been granted permission to authorize the immunization registry integration module 220. As discussed above, an authorized user may include, but is not limited to, the patient, the patient's parent or guardian, the patient's primary physician, a school administrator for a school being attended (or that has been attended) by the patient, or other such user or combination of users.

In one embodiment, the state immunization registry data 224 includes immunization information for a person maintained by, or registered with, a state. It should be understood that, in this context, the state immunization registry data 224 may include state immunization data from one or more states for one or more persons. For example, the state immunization registry data 224 may include state immunization information for a person that has lived in two states. In one embodiment, the state immunization registry data 224 includes one or more state immunization data attributes that include, but are not limited to, a person's full legal name, a person's date of birth, a person's contact information (e.g., mailing address, phone numbers, e-mail addresses, etc.), a person's patient identifier that the state uses to identify the person (or his or her patient record), and one or more immunizations administered to the person, including any kind of vaccination codes that the state may use along with the date(s) that the immunization was administered. As used in this context, and as with the student(s) roster data 222, a state immunization registry data attribute corresponds to an element of the state immunization registry data 224 (e.g., “Legal Name”) and the state immunization registry data attribute value corresponds to the value for the state immunization registry data attribute (e.g., “John Q. Smith”).

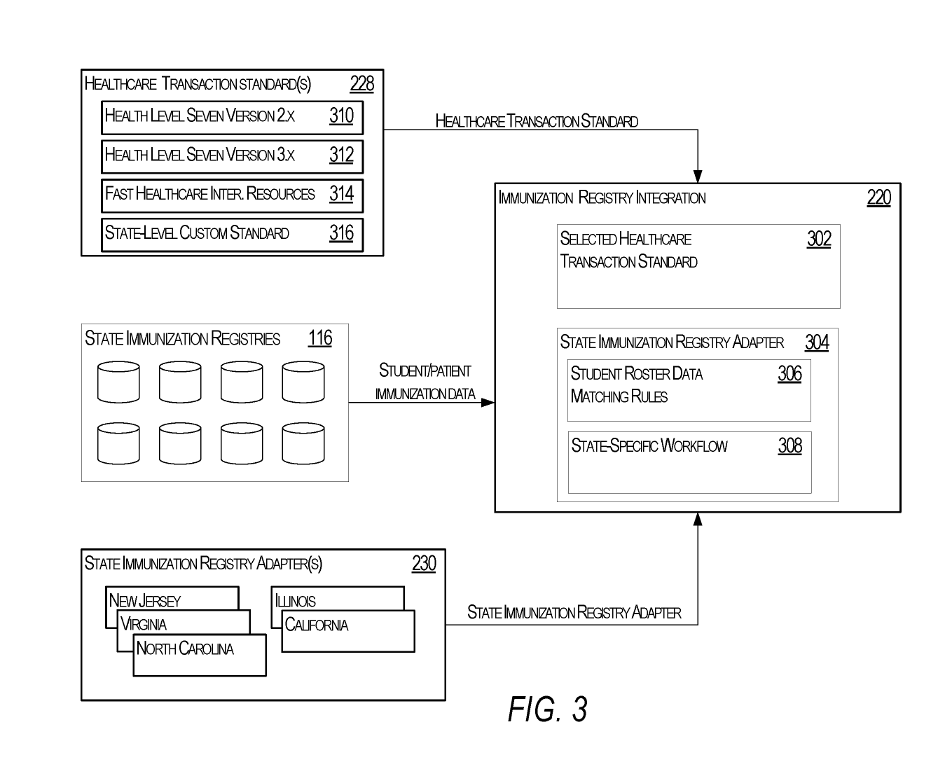

In retrieving the state immunization registry data 224. the immunization registry server 112 is configured to handle the different transaction standards and electronic record keeping maintained by the various states. In this regard, the immunization registry integration module 220 leverages one or more defined healthcare transaction standard(s) 228 and state immunization registry adapter(s) 230 to obtain the state immunization registry data 224. FIG. 3 illustrates obtaining and integrating the student(s) roster data 222 and the state immunization registry data 224 using one or more state immunization registry adapters 230, according to an example embodiment.

As shown in FIG. 3. the immunization registry integration module 220 accepts as input a selected healthcare transaction standard 302 selected from the healthcare transaction standard(s) 228 and a selected state immunization registry adapter 304 selected from the state immunization registry adapter(s) 230. As discussed below, and in one embodiment, the state immunization registry adapter 304 instructs the immunization registry integration module 220 which healthcare transaction standard 302 to select. Similarly, the state immunization registry adapter 304 may be selected according to the initial demographic information provided by the student/patient (or the patient's parents/guardians) (e.g., using the patient's home address or other contact information) and/or according to the student(s) roster data 222 associated with the student/patient. Using the selected healthcare transaction standard 302 and the selected state immunization registry adapter 304, the immunization registry integration module 220 obtains the state immunization registry data 224 from a selected state immunization registry 116.

In general, hospitals and other healthcare provider organizations typically have many different computer systems used for everything from billing records to patient tracking. All of these systems are often configured to communicate with each other (or “interface”) when they receive new information, or when they wish to retrieve information. A healthcare transaction standard specifies a set of rules that allow information to be shared and processed in a uniform and consistent manner. These data standards are meant to allow healthcare organizations to easily share clinical information. Theoretically. this ability to exchange information should help to minimize the tendency for medical care to be geographically isolated and highly variable.

Although a healthcare organization. such as a state immunization registry, may employ a healthcare transaction standard for electronic communications, the healthcare transaction standard employed by one healthcare organization may be different than the healthcare transaction standard employed by another healthcare organization. Thus, knowledge about the healthcare transaction standard is beneficial because it allows an entity, such as the immunization registry server 112. to effectively communicate with the healthcare organization.

However, there exists many different healthcare transaction standards including Health Level-7 (HL7) Version 2.X Messaging Standard, the HL7 Version 3.X Messaging Standard, the Fast Healthcare Interoperability Resources Standard (FHIR), and other such standards. Further still, the healthcare organization (e.g., a selected state immunization registry) may decide to employ its own proprietary standard for electronic communications.

Accordingly, in one embodiment, the immunization registry server 112 is configured with one or more healthcare transaction standard(s) 228 as illustrated in FIG. 3. The standards include, but are not limited to, the HL7 Version 2.X Messaging standard 310, the HL7 Version 3.X Messaging standard 312, the FHIR standard 314, and one or more proprietary standards (e.g., custom standards) 316 that a state immunization registry may employ. Each of these standards 310-316 are selectable by the immunization registry integration module 220 for obtaining the state immunization registry data 224 for a corresponding state immunization registry. In particular, and in one embodiment, when the immunization registry integration module 220 selects a state immunization registry adapter (e.g., the state immunization registry adapter 304). the state immunization registry adapter 304 instructs the immunization registry integration module 220 which healthcare transaction standard 228 to select. The healthcare transaction standard 228 identified by the state immunization registry adapter 304 is then loaded as the selected healthcare transaction standard 302.

Thus, in this manner, the immunization registry integration module 220 is flexible enough to support many different healthcare transaction standards, regardless of which healthcare transaction standard is employed. Further still, should a state immunization registry change its healthcare transaction standard, the corresponding state immunization registry adapter can be updated to reflect that the new (or changed) healthcare transaction standard is being used.

In addition to instructing the immunization registry integration module 220 as to which healthcare transaction standard 228 to use in acquiring the state immunization registry data 224, the state immunization registry adapter 304 also includes a set of student roster data matching rules 306 and a state-specific workflow 308 for integrating the state immunization registry data 224 obtained from the selected state immunization registry of the state immunization registries 116. In one embodiment, the student roster data matching rules 306 instruct the immunization registry integration module 220 as to which data fields of the state immunization registry data 224 to use in matching a given patient's state immunization registry data 224 with the patient's student roster data 222. Similarly, in one embodiment, the state-specific workflow 308 includes one or more rules and/or operations that instruct the immunization registry integration module 220 as to how the state immunization registry data 224 is imported and merged with the student roster data 222 and any other healthcare data that may be provided to the immunization registry server 112 (e.g., via a parent, guardian. healthcare provider, etc.).

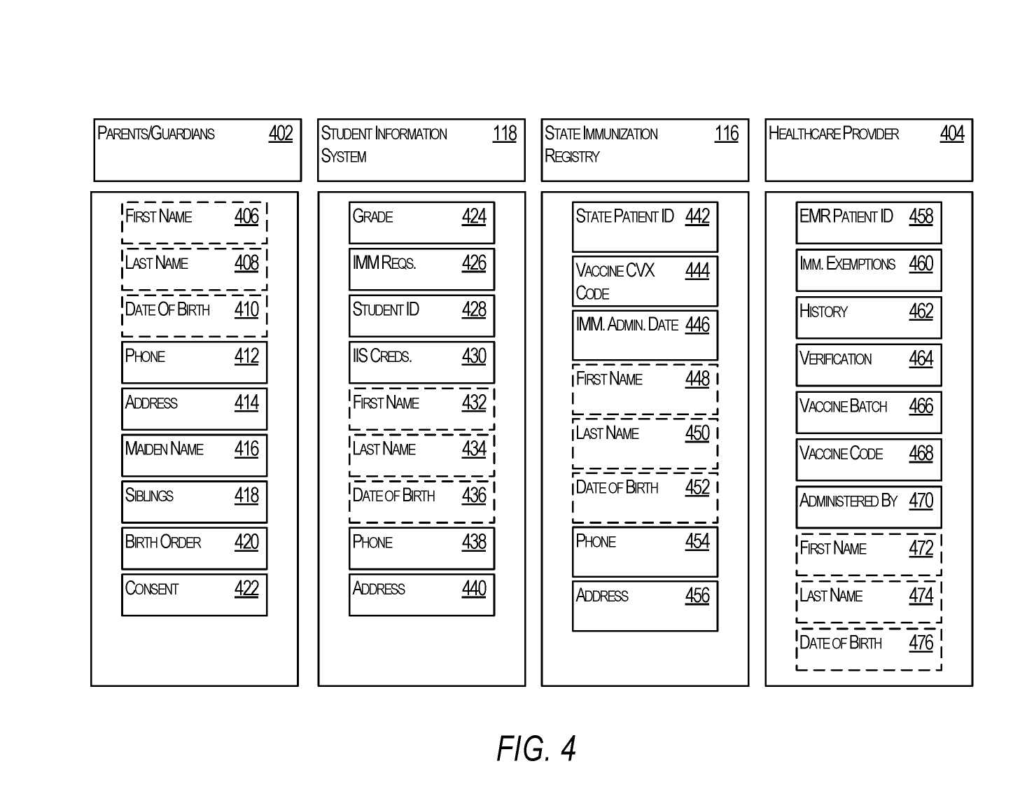

Incorporating healthcare information from disparate systems can be challenging because the healthcare information (e.g., the data itself) may be maintained in different formats or organized differently from system to system. FIG. 4 illustrates identifying different healthcare records across different domains corresponding to an identified patient, according to an example embodiment. As shown in FIG. 4. the sources of healthcare information for a given patient (e.g., a student) may include the parents and/or guardians 402 for the patient, one or more student information system 118, one or more state immunization registry 116. and one or more healthcare provider 404. Each of the sources of healthcare information may provide a variety of healthcare information, which may be structured differently depending on the source of the healthcare information and/or the healthcare transaction standard 228 used in communicating the healthcare information.

In one embodiment, the guardians 402 of the patient provide the healthcare information attributes 406-422, the student information system 118 provides the healthcare information attributes 424-440, the state immunization registry 116 provides the healthcare information attributes 442-456, and the healthcare provider 404 provides the healthcare information attributes 458-476.

Furthermore, each of the sources of healthcare information may provide such information at different stages of the patient's registration with the immunization registry server 112. For example, the parents/guardians 402 may provide the healthcare information attributes 424-440 when the patient initially registers with the immunization registry server 112, and the student information system 118 and/or the state immunization registry 116 may provide their healthcare information after the student/patient registers with the immunization registry server 112. Similarly. the healthcare provider 404 may provide the patient's healthcare information once the student/patient has registered with the immunization registry server 112 and, in some embodiments, after the student(s) roster data 222 and/or the state immunization registry data 224 has been obtained by (or provided to) the immunization registry server 112.

In addition, there can be challenges in integrating the healthcare information from the various healthcare information sources, which the immunization registry integration module 220 addresses. As shown in FIG. 4, there may not be a direct one-to-one relationship among the various healthcare information attributes 406-476. Accordingly. in one embodiment, the student roster data matching rules 306 and/or the state-specific workflow 308 specify the manner in which identifying information provided by one healthcare information source (e.g., the parents/guardians 402) should be matched with identifying information provided by a second healthcare information source (e.g., the student information system 118 and/or the state immunization registry 116).

In this regard, there may be selected healthcare information attributes that form the basis for matching the healthcare information for a given patient/student. As shown in FIG. 4, these healthcare information attributes include the healthcare information attributes 406-410 provided by the parents/guardians 402, the healthcare information attributes 432-436 provided by the student information system 118, the healthcare information attributes 448-452 provided by the state immunization registry 116, and the healthcare information attributes 472-476 provided by the healthcare provider 404. In this embodiment, the initial matching information for the student/patient includes the student/patient's first name, the student/patient's last name, and the student/patient's date of birth.

In addition, the student roster data matching rules 306 may specify secondary or tertiary healthcare information attributes 406-476 to use in matching a student/patient healthcare information. In one embodiment, the student roster data matching rules 306 specify the secondary or tertiary healthcare information attributes 406-476. For example, the secondary healthcare information attribute(s) may include the address of the student/patient (e.g., the healthcare information attribute 414, 440, 456) and the tertiary healthcare information attribute(s) may include the phone number of the student/patient (e.g., the healthcare information attribute 412, 438, 454). Where the immunization registry integration module 220 is unable to match a set of healthcare information attributes 406-476 from one source (e.g., healthcare information attributes 424-440) with another set of healthcare information attributes 406-476 from another source (e.g., healthcare information attributes 442-456). the immunization registry integration module 220 may request that an authorized user (e.g., the student/patient, the parents/guardians 402. or the healthcare provider 404) to provide additional information to help resolve the inability to match the healthcare information attributes.

While the foregoing description provides one manner of matching healthcare information attributes 406-476. there may be other implementations in which the healthcare information attributes 406-476 are selected and/or matched to facilitate the integration of the universal healthcare record. In one embodiment, the immunization registry integration module 220 queries the one or more sources of healthcare information at scheduled intervals or when one or more conditions are met (e.g., an update is detected in one or more of the healthcare information attributes 406-476). Additionally or alternatively, the immunization registry integration module 220 is configured to request moderation or review of the unmatched healthcare information attributes 406-476 in the event that the immunization registry server 112 is unable to match a student/patient record from one or more of the sources of healthcare information.

Referring back to FIG. 2. and in one embodiment, the immunization registry server 112 is configured to validate the healthcare information obtained from the various sources of healthcare information (e.g., the state immunization registries 116, the student information system(s) 118, the healthcare provider 404, etc.). In one embodiment, the immunization registry integration module 220 and/or the immunization compliance engine 218 executes one or more integration integrity rule(s) 232 to validate the student(s) roster data 222 and/or the state immunization registry data 224. In particular, the integration integrity rule(s) 232 facilitate the identification of potential problems or issues with the state immunization registry data 224 and/or the student(s) roster data 222 prior to merging such data 222, 224 into the integrated immunization record(s) 226. For example, and without limitation, the integration integrity rule(s) 232 may be configured with an immunization schedule for one or more immunizations, and such scheduling may be compared with the immunization schedule of the obtained state immunization registry data 224. Where the state immunization registry data 224 indicates that an immunization is off-schedule or has a discrepancy in the administration of such immunization, the integration integrity rule(s) 232 are configured to raise an alert with the immunization registry server 112. As an another example, the integration integrity rule(s) 232 may be configured with the types of immunization a student/patient is expected to receive and, where there is a discrepancy in the state immunization registry data 224 (e.g., a selected immunization is missing or there are multiple entries of such immunization), the integration integrity rule(s) 232 are configured to raise another alert with the immunization registry server 112. The immunization registry server 112 is configured to track such alerts and, in one embodiment, requests that an authorized user (e.g., the student/patient, the parents or guardians of such student/patient. etc.) review the alerts prior to merging the data having the discrepancy into the integrated immunization record(s) 226.

After the discrepancies and/or any alerts have been resolved, the state immunization registry data 224 and/or the student(s) roster data 222 are then merged into the integrated immunization record(s) 226. It should be understood that in alternative embodiments, the immunization registry server 112 integrates the student(s) roster data 222 and/or the state immunization registry data 224 regardless of whether there are discrepancies in either sets of data.

In addition, the immunization registry server 112 is configured to evaluate the integrated immunization record(s) 226 to ensure compliance with a designated school district or other educational institution where a selected student/patient may be attending. Accordingly, the immunization registry server 112 is configured with (or communicates with) an immunization compliance engine 218 that determines whether a selected integrated immunization record is in compliance with a corresponding school district or other educational institution. In one embodiment, the immunization compliance engine 218 is implemented as the Immunization Calculation Engine (ICE). which is an open-source software system that provides clinical decision support for immunizations (CDSi), and is available from HLN Consulting, LLC located in Palm Desert. Calif. The immunization compliance engine 218 informs an authorized user or other administrator of the immunization registry server 112 whether one or more of the integrated immunization record(s) 226 are in compliance with corresponding immunization requirements.

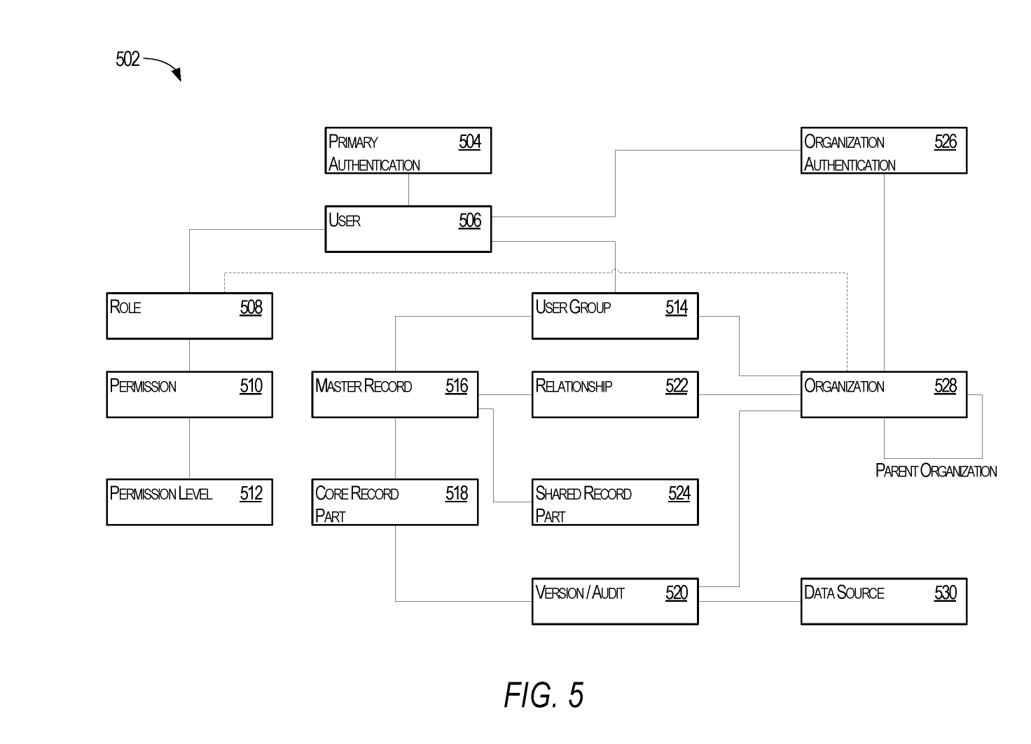

As the immunization registry server 112 manages complex healthcare records (e.g., the integrated immunization record(s) 226), a data model is disclosed that represents one way in which the integrated immunization record(s) 226 are managed. FIG. 5 illustrates a data model 502 for an integrated immunization record, according to an example embodiment. As shown in FIG. 5, the data model 502 defines a primary authentication 504 that is linked with a user 506, which is in turn associated with a user role 508 and an organization authentication 526. In addition, the role 508 is associated with various permissions 510 and permission levels 512, which define the authorization and access permissions for the user 506.

The user 506 can also be associated with a user group 514, which is in turn associated with a master record 516 and an organization identifier 528. The user group 514 identifies a user group to which the user 506 belongs. Furthermore, the user 506 may be associated with multiple user groups (identified by the user group 514). where each user group 514 has access to different integrated immunization record(s) 226 and/or different permission levels for different integrated immunization record(s) 226. Accordingly. depending on the user group 514 assigned or associated with a user 506, the user 506 may have different types of access to different integrated immunization record(s) 226.

In addition, the master record 516 is divided into at least two parts: a core record part 518 and a shared record part 524. The core record part 518 includes those healthcare information attributes which may not be accessible to other users. The shared record part 524 may include those healthcare information attributes which are accessible by other users (or designated users) of the immunization registry server 112. Accordingly, the core record part 518 is associated with a version/audit identifier 520 and a data source 530. Finally, the master record 516 is associated with a relationship identifier 522 that identifies one or more relationships between the master record 516 and organizations (e.g., one or more organizations 528). In this regard, the master record 516 may have multiple relationships with multiple organizations.

With the data model 502 illustrated in FIG. 5. it is possible to grant different levels of access to different users for different parts of an integrated immunization record. Thus, for a given integrated immunization record, different users may be able to view different portions of the integrated immunization record. and different users may have different permissions (e.g., read, edit, delete, add, etc.) with respect to those portions. For example, an authorized user can be part of multiple user groups (e.g., identified by user group 514). where each user group is connected to one entity, where the entity is an integrated immunization record (e.g., identified by master record 516). Alternatively, the user group 514 may be connected to an organization node (e.g., identified by organization 528) in a hierarchy of organizations which have relationships to many integrated immunization records.

As one example, suppose that a parent/guardian (e.g., a mother) belongs to his or her child's integrated immunization record user group. A school nurse could also belong to this user group and have access to all students enrolled (e.g., identified by the relationship identifier 522) in that school (e.g., identified by the organization 528). A coach for the school may also be assigned to the user group 514 for a sports team associated with the school, but this coach may be assigned access to only immunization records for students/patients that are members of the sports team (e.g., identified by organization 528 and/or relationship 522). Adding further complexity to this example, the coach could also be assigned to a user group for his or her son directly (e.g., via a connection between master record 516 and user group 514) that also goes to the school, but is not on the football team.

In addition, with the implementation of a version/audit identifier 520. the immunization registry server 112 can track changes to the master record 516 and/or the core record part 518, so past relationships can be reported on even as transient access changes, such as where a student/patient changes schools or school districts.

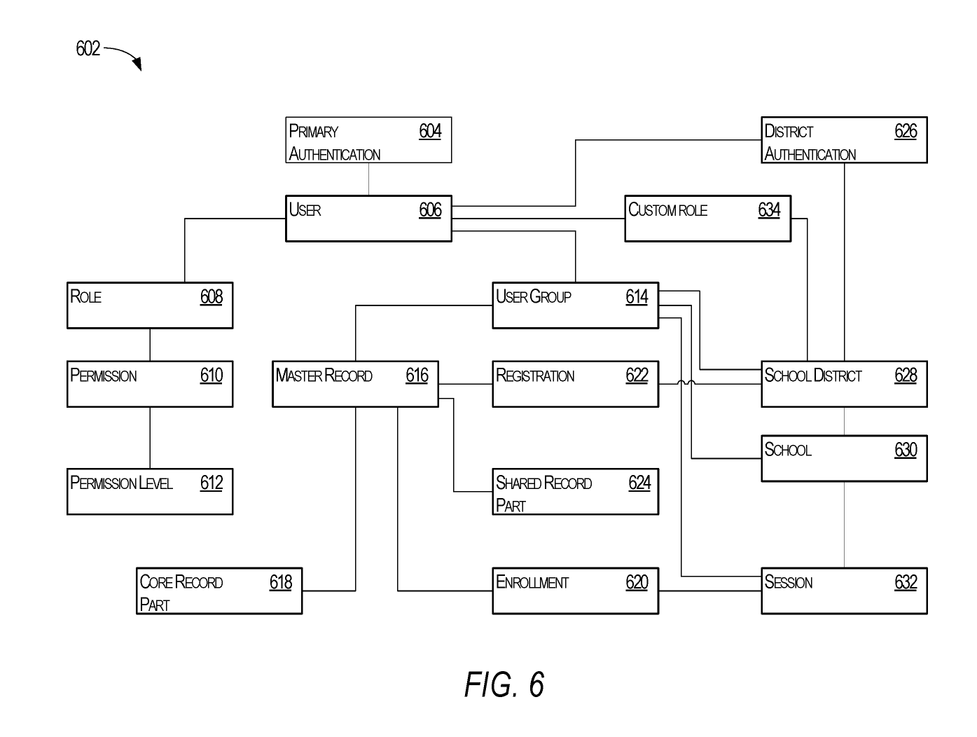

To facilitate a better understanding of the data model 502. FIG. 6 illustrates one implementation 602 of the data model 502. according to an example embodiment. As illustrated in FIG. 6. there is an almost one-to-one correspondence between the entities 604-634 of FIG. 6 and the entities 504-530 of FIG. 5. As illustrated in FIG. 6, the user group 614 for this particular implementation 602 is associated with two organizations: a school district (e.g., identified by the school district 628) and a school (e.g., identified by the school 630). A custom role 634 has also been defined that can set out permissions specific to the associated entities, such as the school district 628 and the school 630. Finally, the enrollment entity 620 (corresponding to the version/audit identifier 520 of FIG. 5) identifies that this particular implementation 602 is associated with healthcare information that was provided during a student's enrollment, which was obtained during a session with the integrated immunization registry server 112 (e.g., identified by the session entity 632).

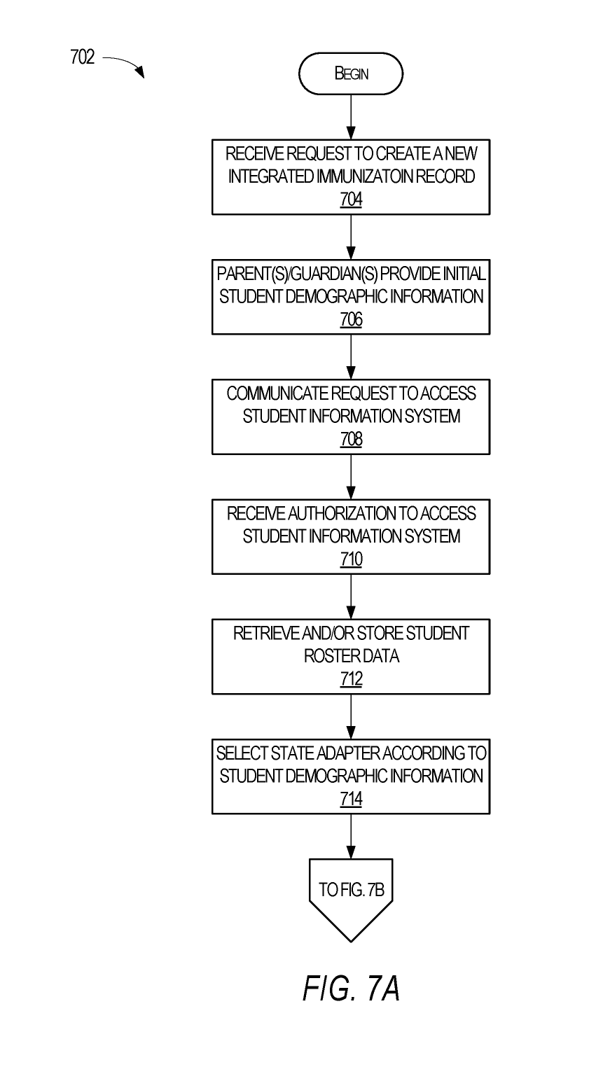

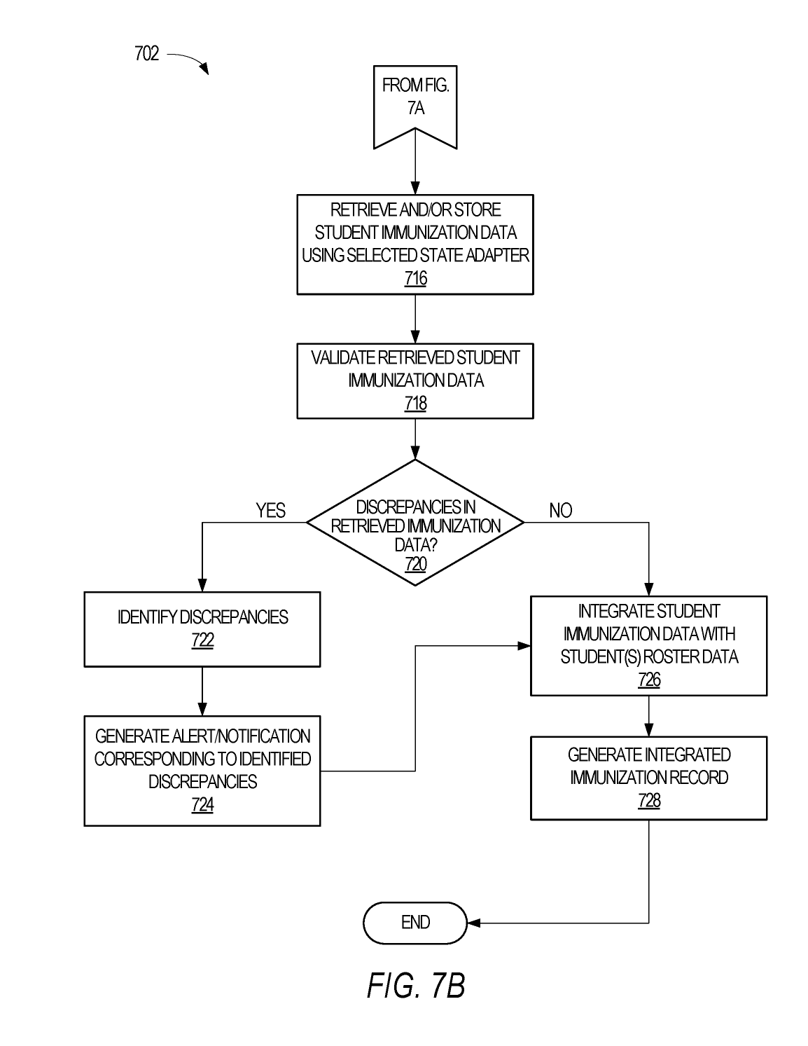

FIGS. 7A-7B illustrate a method 702, in accordance with an example embodiment, for integrating healthcare records obtained from various sources into an integrated immunization record. The method 702 may be implemented by one or more components of the integrated immunization registry server 112 and is discussed by way of reference thereto.

Initially. and referring to FIG. 7A, the integrated immunization registry server 112 may receive a request to create a new integrated immunization record (Operation 704). As explained above, such request may be received from an authorized user of the integrated immunization registry server 112 via the user interface module 212. In one embodiment, the authorized user is granted authorization after registering (e.g., by creating a user, student, or patient profile), with the immunization registry server 112.

Thereafter, the user interface module 212 may provide one or more graphical user interfaces for the authorized user to provide student demographic information for the student/patient associated with the newly created integrated immunization record (Operation 706). As explained above, using the demographic information provided, the immunization registry server 112 may then request access to one or more student information system(s) 118 to obtain healthcare information corresponding to the student/patient being registered with the immunization registry server 112 (Operation 708). In one embodiment, this request is communicated during the registration process of the student/patient; alternatively and/or additionally, the authorization to access the one or more student information system(s) 118 may be explicitly provided during the registration process (Operation 710).

Using the provided authorization credentials, the immunization registry server 112 then obtains student(s) roster data 222 from the one or more student information system(s) 118 (Operation 712). In addition, based on the provided initial demographic information and/or the healthcare information associated with the student(s) roster data 222, the immunization registry server 112 selects a state immunization registry adapter 230 for accessing a corresponding state immunization registry 116 (Operation 714). As with accessing the student information system(s) 118, the immunization registry server 112 may also request access to the state immunization registry 116 that stores healthcare information for the student/patient being registered with the immunization registry server 112.

Referring next to FIG. 7B, the immunization registry server 112 then obtains the state immunization registry data 224 from a selected state immunization registry 116 (Operation 716). As discussed with reference to FIG. 3, retrieving and/or obtaining the state immunization registry data 224 may include selecting one or more healthcare transaction standard(s) 228 and/or one or more state immunization registry adapter(s) 230. Furthermore, the selected state immunization registry adapter 230 may include one or more student roster data matching rules 306 and/or state-specific workflows 308 for integrating the state immunization registry data 224 with the obtained student(s) roster data 222.

Thereafter. and as discussed with reference to FIG. 2, the immunization registry server 112 may then validate the obtained state immunization registry data 224 (Operation 718). In one embodiment, the state immunization registry data 224 is validated according to one or more integration integrity rule(s) 232. Additionally. or alternatively, the validation of such state immunization registry data 224 may be performed by the immunization registry integration module 220 during the process of integrating the state immunization registry data 224 with the student(s) roster data 222.

During the validation process. one or more discrepancies in the state immunization registry data 224 and/or the student(s) roster data 222 may be determined (Operation 720). Where discrepancies are determined (e.g., “YES” branch of Operation 720). the immunization registry server 112 then identifies which portions of the obtained data (e.g., the healthcare information attributes 406-476) have the determined discrepancies (Operation 722). The immunization registry server 112 may then generate one or more alerts and/or notifications alerting an authorized user to the discrepancies (Operation 724). which an authorized user may then correct or rectify during a subsequent interaction with the immunization registry server 112. Thereafter, the method 702 may then proceed to Operation 726.

Where the immunization registry server 112 determines that are no discrepancies in the obtained data (e.g., “NO” branch of Operation 720), the immunization registry server 112 then integrates the student(s) roster data 222 with the state immunization registry data 224 (Operation 726). In one embodiment, and as discussed with reference to FIGS. 5-6, the immunization registry server 112 may create one or more integrated immunization record(s) 226 which conform to a data model 502 designed to accommodate the complexities involved in having different types of users (e.g., a student, a parent/guardian, a school administrator, etc.) needing access to healthcare information associated with a given student/patient. Furthermore, integrating the state immunization registry data 224 with the student roster(s) data 222 may also include performing one or more matches of healthcare information attributes 406-476 as discussed with reference to FIG. 4.

As a result of the integration. the immunization registry server 112 generates a corresponding integrated immunization record 226 (Operation 728). One or more portions of the integrated immunization record 226 may then be provided and/or displayed to the client device 104 via the user interface module 212.

In this manner, the disclosure provides an immunization registry server 112 that acquires and integrates healthcare information from different systems in which the healthcare information may be stored and/or accessed using different healthcare transaction standards. The result of integrating this information is the integrated immunization record, which conforms to a data model that can accommodate the access needs for different types of users. As the healthcare information may be stored using different methodologies and/or implementations. one of the technical benefits of the disclosed immunization registry server 112 is that it can acquire such healthcare data across various domains without requiring further configuration or input from a user registered with the immunization registry server 112. Furthermore, as the immunization registry server 112 implements various integrity and compliance measures, the immunization registry server 112 addresses the technical challenges involved in maintaining information that is readily suspect to user error. These and other such challenges are unique in the field of information processing and data integration.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system. a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry. or in temporarily configured circuitry (e.g., configured by software) may be driven by cost and time considerations.

Accordingly. the phrase “hardware module” should be understood to encompass a tangible entity, be that an entity that is physically constructed, permanently configured (e.g., hardwired). or temporarily configured (e.g., programmed) to operate in a certain manner or to perform certain operations described herein. As used herein. “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously. communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially. by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented. with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 1-7B are implemented in some embodiments in the context of a machine and an associated software architecture. The sections below describe a representative architecture that is suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things” while yet another combination produces a server computer for use within a cloud computing architecture. Not all combinations of such software and hardware architectures are presented here as those of skill in the art can readily understand how to implement the inventive subject matter in different contexts from the disclosure contained herein.

### Example Machine Architecture and Machine-Readable Medium

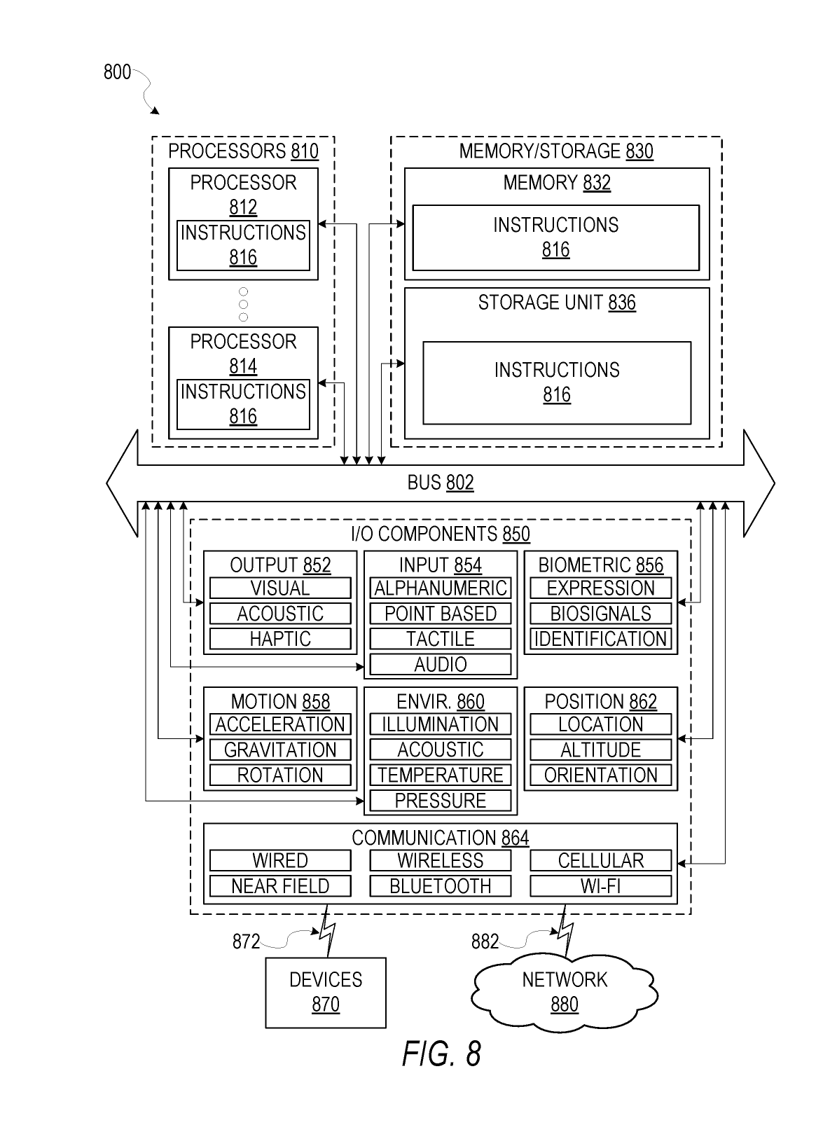

FIG. 8 is a block diagram illustrating components of a machine 800, according to some example embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system. within which instructions 816 (e.g., software, a program, an application, an applet, an app, or other executable code) for causing the machine 800 to perform any one or more of the methodologies discussed herein may be executed. For example, the instructions 816 may cause the machine 800 to execute the flow diagrams of FIGS. 7A-7B. Additionally, or alternatively, the instructions 816 may implement one or more of the components of FIG. 2. The instructions 816 transform the general, non-programmed machine 800 into a particular machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a personal digital assistant (PDA). or any machine capable of executing the instructions 816, sequentially or otherwise, that specify actions to be taken by machine 800. Further, while only a single machine 800 is illustrated, the term “machine” shall also be taken to include a collection of machines 800 that individually or jointly execute the instructions 816 to perform any one or more of the methodologies discussed herein.

The machine 800 may include processors 810, memory/storage 830. and I/O components 850, which may be configured to communicate with each other such as via a bus 802. In an example embodiment, the processors 810 (e.g., a Central Processing Unit (CPU). a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC). another processor, or any suitable combination thereof) may include, for example, processor 812 and processor 814 that may execute the instructions 816. The term “processor” is intended to include multi-core processor that may comprise two or more independent processors (sometimes referred to as “cores”) that may execute instructions 816 contemporaneously. Although FIG. 8 shows multiple processors 810, the machine 800 may include a single processor with a single core, a single processor with multiple cores (e.g., a multi-core process), multiple processors with a single core, multiple processors with multiples cores, or any combination thereof.

The memory/storage 830 may include a memory 832, such as a main memory, or other memory storage, and a storage unit 836, both accessible to the processors 810 such as via the bus 802. The storage unit 836 and memory 832 store the instructions 816 embodying any one or more of the methodologies or functions described herein. The instructions 816 may also reside, completely or partially. within the memory 832. within the storage unit 836. within at least one of the processors 810 (e.g., within the processor's cache memory), or any suitable combination thereof, during execution thereof by the machine 800. Accordingly, the memory 832, the storage unit 836, and the memory of processors 810 are examples of machine-readable media.

As used herein, “machine-readable medium” means a device able to store instructions 816 and data temporarily or permanently and may include, but is not limited to, random-access memory (RAM), read-only memory (ROM), buffer memory, flash memory. optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 816. The term “machine-readable medium” shall also be taken to include any medium, or combination of multiple media, that is capable of storing instructions (e.g., instructions 816) for execution by a machine (e.g., machine 800), such that the instructions, when executed by one or more processors of the machine 800 (e.g., processors 810). cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 850 may include a wide variety of components to receive input, provide output, produce output. transmit information, exchange information. capture measurements, and so on. The specific I/O components 850 that are included in a particular machine will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion and the grouping is in no way limiting. In various example embodiments, the I/O components 850 may include output components 852 and input components 854. The output components 852 may include visual components (e.g., a display such as a plasma display panel (PDP), a light emitting diode (LED) display, a liquid crystal display (LCD). a projector, or a cathode ray tube (CRT)), acoustic components (e.g., speakers). haptic components (e.g., a vibratory motor. resistance mechanisms), other signal generators, and so forth. The input components 854 may include alphanumeric input components (e.g., a keyboard, a touch screen configured to receive alphanumeric input. a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 850 may include biometric components 856. motion components 858, environmental components 860, or position components 862 among a wide array of other components. For example, the biometric components 856 may include components to detect expressions (e.g., hand expressions, facial expressions. vocal expressions, body gestures. or eye tracking), measure biosignals (e.g., blood pressure. heart rate, body temperature. perspiration, or brain waves). identify a person (e.g., voice identification, retinal identification, facial identification, fingerprint identification, or electroencephalogram based identification), and the like. The motion components 858 may include acceleration sensor components (e.g., accelerometer), gravitation sensor components, rotation sensor components (e.g., gyroscope). and so forth. The environmental components 860 may include, for example, illumination sensor components (e.g., photometer). temperature sensor components (e.g., one or more thermometer that detect ambient temperature), humidity sensor components, pressure sensor components (e.g., barometer), acoustic sensor components (e.g., one or more microphones that detect background noise). proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 862 may include location sensor components (e.g., a Global Position System (GPS) receiver component), altitude sensor components (e.g., altimeters or barometers that detect air pressure from which altitude may be derived), orientation sensor components (e.g., magnetometers). and the like.

Communication may be implemented using a wide variety of technologies. The I/O components 850 may include communication components 864 operable to couple the machine 800 to a network 880 or devices 870 via coupling 882 and coupling 872 respectively. For example, the communication components 864 may include a network interface component or other suitable device to interface with the network 880. In further examples, communication components 864 may include wired communication components. wireless communication components, cellular communication components. Near Field Communication (NFC) components, Bluetooth® components (e.g., Bluetooth® Low Energy). Wi-Fi® components, and other communication components to provide communication via other modalities. The devices 870 may be another machine or any of a wide variety of peripheral devices (e.g., a peripheral device coupled via a Universal Serial Bus (USB)).

Moreover, the communication components 864 may detect identifiers or include components operable to detect identifiers. For example, the communication components 864 may include Radio Frequency Identification (RFID) tag reader components. NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph. MaxiCode, PDF416, Ultra Code. UCC RSS-2D bar code, and other optical codes), or acoustic detection components (e.g., microphones to identify tagged audio signals). In addition, a variety of information may be derived via the communication components 864. such as location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 880 may be an ad hoc network, an intranet. an extranet, a virtual private network (VPN), a local area network (LAN), a wireless LAN (WLAN), a wide area network (WAN), a wireless WAN (WWAN), a metropolitan area network (MAN), the Internet. a portion of the Internet, a portion of the Public Switched Telephone Network (PSTN). a plain old telephone service (POTS) network, a cellular telephone network, a wireless network, a Wi-Fi® network, another type of network, or a combination of two or more such networks. For example, the network 880 or a portion of the network 880 may include a wireless or cellular network and the coupling 882 may be a Code Division Multiple Access (CDMA) connection, a Global System for Mobile communications (GSM) connection, or other type of cellular or wireless coupling. In this example, the coupling 882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks. Universal Mobile Telecommunications System (UMTS). High Speed Packet Access (HSPA), Worldwide Interoperability for Microwave Access (WiMAX). Long Term Evolution (LTE) standard, others defined by various standard setting organizations, other long range protocols, or other data transfer technology.

The instructions 816 may be transmitted or received over the network 880 using a transmission medium via a network interface device (e.g., a network interface component included in the communication components 864) and utilizing any one of a number of well-known transfer protocols (e.g., hypertext transfer protocol (HTTP)). Similarly. the instructions 816 may be transmitted or received using a transmission medium via the coupling 872 (e.g., a peer-to-peer coupling) to devices 870. The term “transmission medium” shall be taken to include any intangible medium that is capable of storing, encoding. or carrying instructions 816 for execution by the machine 800, and includes digital or analog communications signals or other intangible medium to facilitate communication of such software.

### Language

Throughout this specification. plural instances may implement components, operations, or structures described as a single instance. Although individual operations of one or more methods are illustrated and described as separate operations. one or more of the individual operations may be performed concurrently. and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A system comprising:
a machine-readable medium storing computer-executable instructions; and
at least one hardware processor communicatively coupled to the machine-readable medium that, when the computer-executable instructions are executed, configures the system to:
receive a request to create an integrated immunization record, the request including initial demographic information for a patient to be associated with the integrated immunization record;
obtain student roster data associated with the patient from a student information system associated with an educational institution, the student roster data including healthcare information maintained by the student information system;
determine a state-specific adapter based on the initial demographic information, the state-specific adapter configured to obtain state immunization data from a state immunization system associated with a corresponding state identified in the initial demographic information;
obtain the state immunization data corresponding to the patient using the determined state-specific adapter;
integrate the obtained state immunization data and the obtained student roster data into an integrated immunization record, the integrated immunization record comprising at least a portion of the obtained student roster data and a portion of the state immunization data; and
generate the integrated immunization record corresponding to the patient.

2. The system of claim 1, wherein the system is further configured to determine whether a discrepancy exists in the state immunization data according to one or more integration integrity rules, at least one integration integrity rule specifying an immunization schedule for an immunization associated with the patient.

3. The system of claim 2, wherein the system determines that a discrepancy exists in the state immunization data in response to a determination that an immunization schedule associated with the patient differs from the specified immunization schedule.

4. The system of claim 1, wherein the state-specific adapter includes one or more student roster data matching rules specifying how the obtained student roster data is to be matched with the state immunization data to be obtained from the state immunization system.

5. The system of claim 1, wherein the system is further configured to select at least one healthcare transaction standard to obtain the state immunization data, the at least one healthcare transaction standard being selected from a plurality of healthcare transaction standards.

6. The system of claim 1, wherein the integrated immunization record is generated to conform with a predefined data model, the predefined data model identifying a portion of the integrated immunization record as a shared portion that is accessible by a plurality of users.

7. The system of claim 6, wherein the system is further configured to provide the shared portion of the integrated immunization record in response to a request by a user selected from the plurality of users, the user being other than the patient associated with the integrated immunization record.

8. A method comprising:
receiving, by at least one hardware processor, a request to create an integrated immunization record, the request including initial demographic information for a patient to be associated with the integrated immunization record;
obtaining, by at least one hardware processor, student roster data associated with the patient from a student information system associated with an educational institution, the student roster data including healthcare information maintained by the student information system:
determining, by at least one hardware processor, a state-specific adapter based on the initial demographic information, the state-specific adapter configured to obtain state immunization data from a state immunization system associated with a corresponding state identified in the initial demographic information;
obtaining, by at least one hardware processor, the state immunization data corresponding to the patient using the determined state-specific adapter;
integrating, by at least one hardware processor, the obtained state immunization data and the obtained student roster data into an integrated immunization record, the integrated immunization record comprising at least a portion of the obtained student roster data and a portion of the state immunization data; and
generating, by at least one hardware processor, the integrated immunization record corresponding to the patient.

9. The method of claim 8, further comprising:
determining whether a discrepancy exists in the state immunization data according to one or more integration integrity rules, at least one integration integrity rule specifying an immunization schedule for an immunization associated with the patient.

10. The method of claim 9, wherein a discrepancy is determined to exist in the state immunization data in response to a determination that an immunization schedule associated with the patient differs from the specified immunization schedule.

11. The method of claim 8, wherein the state-specific adapter includes one or more student roster data matching rules specifying how the obtained student roster data is to be matched with the state immunization data to be obtained from the state immunization system.

12. The method of claim 8, further comprising:
selecting at least one healthcare transaction standard to obtain the state immunization data, the at least one healthcare transaction standard being selected from a plurality of healthcare transaction standards.

13. The method of claim 8, wherein the integrated immunization record is generated to conform with a predefined data model, the predefined data model identifying a portion of the integrated immunization record as a shared portion that is accessible by a plurality of users.

14. The method of claim 13, further comprising:
providing the shared portion of the integrated immunization record in response to a request by a user selected from the plurality of users, the user being other than the patient associated with the integrated immunization record.

15. A machine-readable medium storing computer-executable instructions thereon that, when executed by at least one hardware processor, causes a system to perform a plurality of operations, the operations comprising:
receiving a request to create an integrated immunization record, the request including initial demographic information for a patient to be associated with the integrated immunization record;
obtaining student roster data associated with the patient from a student information system associated with an educational institution, the student roster data including healthcare information maintained by the student information system;
determining a state-specific adapter based on the initial demographic information, the state-specific adapter configured to obtain state immunization data from a state immunization system associated with a corresponding state identified in the initial demographic information;
obtaining the state immunization data corresponding to the patient using the determined state-specific adapter;
integrating the obtained state immunization data and the obtained student roster data into an integrated immunization record, the integrated immunization record comprising at least a portion of the obtained student roster data and a portion of the state immunization data; and
generating the integrated immunization record corresponding to the patient.

16. The machine-readable medium of claim 15, wherein the plurality of operations further comprise:
determining whether a discrepancy exists in the state immunization data according to one or more integration integrity rules, at least one integration integrity rule specifying an immunization schedule for an immunization associated with the patient.

17. The machine-readable medium of claim 16, wherein a discrepancy is determined to exist in the state immunization data in response to a determination that an immunization schedule associated with the patient differs from the specified immunization schedule.

18. The machine-readable medium of claim 15, wherein the state-specific adapter includes one or more student roster data matching rules specifying how the obtained student roster data is to be matched with the state immunization data to be obtained from the state immunization system.

19. The machine-readable medium of claim 15, wherein the plurality of operations further comprise:
selecting at least one healthcare transaction standard to obtain the state immunization data, the at least one healthcare transaction standard being selected from a plurality of healthcare transaction standards.

20. The machine-readable medium of claim 15, wherein the integrated immunization record is generated to conform with a predefined data model, the predefined data model identifying a portion of the integrated immunization record as a shared portion that is accessible by a plurality of users.
